(19) United States
(12) Patent Application Publication
(10) Pub. No.: US 2016/0273198 A1
(43) Pub. Date: Sep. 22, 2016

(54) CAPACITANCE SENSING TYPE WATER SUPPLY DEVICE AND METHOD

(71) Applicant: TIEN HO CHUNG, Changhua County (TW)

(72) Inventor: TIEN HO CHUNG, Changhua County (TW)

(21) Appl. No.: 15/074,426

(22) Filed: Mar. 18, 2016

(30) Foreign Application Priority Data
Mar. 20, 2015 (TW) 104108929

(51) Int. Cl. E03C 1/05; G01D 5/24; G01V 3/08

(52) U.S. Cl. CPC E03C 1/057; G01V 3/08; G01D 5/24

(57) ABSTRACT

A capacitance sensing type water supply device includes a metal shell, a capacitance sensor, an electronic control unit and a fluid control unit. There is a capacitive effect between an external object and the metal shell when a distance between the external object and the metal shell is within a first distance range or a second distance range, whereby a corresponding electric value is generated by the metal shell. The capacitance sensor senses the electric value of the metal shell, and then provides the electronic control unit with a corresponding sensing signal, whereby the electronic control unit controls the fluid control unit to drive whether the water of water supply device is supplied, whether the water of water supply device is supplied continuously, whether the flow rate of supplied water of water supply device is changed and whether the temperature of supplied water of water supply device is changed.

### CROSS-REFERENCE TO RELATED APPLICATION

This application claims the benefit of Taiwan Patent Application No.104108929, filed on March 20, 2015, which is hereby incorporated by reference for all purposes as if fully set forth herein.

### BACKGROUND OF THE INVENTION

1. Field of Invention

The present disclosure relates to a capacitance sensing type water supply device and method and more particularly to a touch and a touch free capacitance sensing type water supply device and method, wherein a capacitive effect between an external object and a metal shell when the external object touches or doesn't touch the metal shell, whereby the variation of a current value of the metal shell is sensed so as to control whether water is supplied, whether the flow rate of the supplied water is changed, whether the temperature of the supplied water is changed, or whether the supplied water is drained.

2. Related Art

Today, the technology of a faucet is developed, a conventional touch type faucet which operates a valve of an outlet manually is progressively changed to a touch free automatic type faucet which controls whether water of an outlet is supplied or not. It is more particularly to an infrared sensing type or a capacitance sensing type faucet that is very suitable for public place, commercial place, the appliance of residence and solves problem of personal hygiene caused by the conventional touch type faucet.

The patent reference (Taiwan Patent No. M437408) discloses a capacitance sensing type ceramic faucet. The capacitance sensing type ceramic faucet includes at least one ceramic shell, at least one flow tube, at least one electric control valve, at least one electronic control unit and at least one capacitance sensing electrode. The electronic control unit has the sensing function of capacitance variation. The flow tube passes through an inner of the ceramic shell. An end of the flow tube is communicated with a water source, and the other end of the flow tube is an outlet of the ceramic faucet. The at least one capacitance sensing electrode is disposed on the outlet of the ceramic faucet or the inside or outside of the ceramic shell which is adjacent to the outlet. The electric control valve is disposed to the flow tube. The electronic control unit is electrically connected to the capacitance sensing electrode and the electric control valve. The electronic control unit receives a capacitance value of the capacitance sensing electrode, wherein the capacitance value of the capacitance induction electrode can be changed due to the location change of dielectric matter, such as human body. The variation of the capacitance value is processed by an inner logic operator of the electronic control unit so as to control whether the electric control valve is open or not. Although it solves the personal hygiene problem of the touch type faucet, the applications of the conventional capacitance sensing type ceramic faucet are limited, e.g., water flow or temperature is necessary to control in the kitchen, washroom and lavatory. The usage of the conventional capacitance sensing type ceramic faucet is inadequate.

Therefore, a capacitance sensing type water supply device is required to solve the foregoing problems.

### SUMMARY OF THE INVENTION

The objective of the present disclosure is what provides a capacitance sensing type water supply device and method, wherein a capacitive effect between an external object and a metal shell when the external object touches or doesn't touch the metal shell, whereby the variation of a current value of the metal shell is sensed so as to control whether water is supplied, whether the flow rate of the supplied water is changed, whether the temperature of the supplied water is changed, or whether the supplied water is drained.

To achieve the foregoing objective, the present disclosure provides a capacitance sensing type water supply device, including: a metal shell comprising an inlet, a flow channel and an outlet communicated with the inlet through the flow channel, wherein there is a capacitive effect between an external object and the metal shell when a distance between the external object and the metal shell is within a first distance range or a second distance range, and the distance between the external object and the metal shell within the first distance range is bigger than the distance between the external object and the metal shell within the second distance range, whereby a corresponding electric value is generated by the metal shell; a capacitance sensor electrically connected to the metal shell, and adapted to sense the electric value of the metal shell, and then to output a corresponding sensing signal according to the electric value; an electronic control unit electrically connected to the capacitance sensor, and adapted to receive the sensing signal and then to generate a corresponding driving signal; and a fluid control unit communicated with the inlet of the metal shell, wherein: when the distance between the external object and the metal shell is within the first distance range, the fluid control unit controls whether water of the capacitance sensing type water supply device is supplied according to the driving signal; and when the distance between the external object and the metal shell is within the second distance range, the fluid control unit controls whether water of the capacitance sensing type water supply device is supplied continuously or the flow rate of supplied water according to the driving signal.

The present disclosure mainly utilizes two kinds of distance between the external object (e.g., hand) and the metal shell (e.g., faucet shell) to generate a capacitive effect between the external object and the metal shell when the external object touches or doesn't touch the metal shell, whereby the variation of a current value of the metal shell is sensed by the capacitance sensor, and the electronic control unit and the fluid control unit are utilized to control whether water of the capacitance sensing type water supply device is supplied, whether water is supplied continuously and whether the flow rate of the supplied water is changed. Moreover, simultaneously the present disclosure can utilizes the first to third sensor of the electronic control unit to control whether temperature of the supplied water is changed, whether the potable water is supplied and whether the supplied water is drained.

To make the aforementioned and other objects, features and advantages of the present disclosure clearer, detailed illustration is provided in the following with reference to the accompanying drawings.

### BRIEF DESCRIPTION OF THE DRAWINGS

FIG. 1 is a schematic cross-sectional view of a capacitance sensing type water supply device according to the first embodiment of the present disclosure.

FIG. 2 is a schematic block diagram showing a structure of a main control circuit board and a fluid control unit of a capacitance sensing type water supply device according to the first embodiment of the present disclosure.

FIG. 3 is a schematic cross-sectional view of a fluid control unit according to the first embodiment of the present disclosure.

FIG. 4a is a first schematic view showing the first embodied example of a capacitance sensing type water supply method according to the first embodiment of the present disclosure.

FIG. 4b is a second schematic view showing the first embodied example of a capacitance sensing type water supply method according to the first embodiment of the present disclosure.

FIG. 5a is a first schematic view showing the second embodied example of a capacitance sensing type water supply method according to the first embodiment of the present disclosure.

FIG. 5b is a second schematic view showing the second embodied example of a capacitance sensing type water supply method according to the first embodiment of the present disclosure.

FIG. 6a is a first schematic view showing the fourth embodied example of a capacitance sensing type water supply method according to the first embodiment of the present disclosure.

FIG. 6b is a second schematic view showing the fourth embodied example of a capacitance sensing type water supply method according to the first embodiment of the present disclosure.

FIG. 7 is a schematic block diagram showing a structure of an electronic control unit, a fluid control unit and a drain unit according to the second embodiment of the present disclosure.

FIG. 8 is a schematic cross-sectional view of a fluid control unit according to the second embodiment of the present disclosure.

FIG. 9 is a schematic cross-sectional view of a capacitance sensing type water supply device according to the second embodiment of the present disclosure.

FIG. 10 is a schematic top view showing the first embodied example of a capacitance sensing type water supply method according to the second embodiment of the present disclosure.

FIG. 11 is a schematic cross-sectional view showing city water supply of the first embodied example of a capacitance sensing type water supply method according to the second embodiment of the present disclosure.

FIG. 12 is a schematic top view showing the second embodied example of a capacitance sensing type water supply method according to the second embodiment of the present disclosure.

FIG. 13 is a schematic cross-sectional view showing potable water supply of the second embodied example of a capacitance sensing type water supply method according to the second embodiment of the present disclosure.

FIG. 14 is a schematic cross-sectional view showing drain of the third embodied example of a capacitance sensing type water supply method according to the second embodiment of the present disclosure.

### DETAILED DESCRIPTION OF THE INVENTION

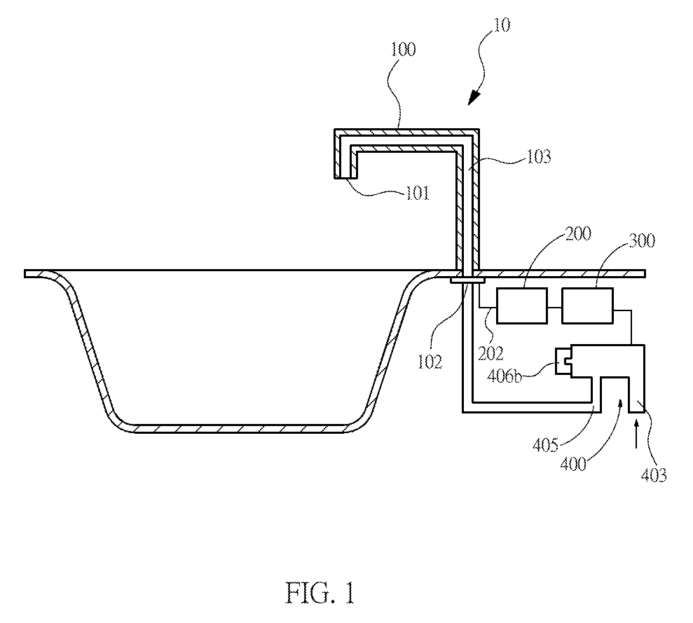

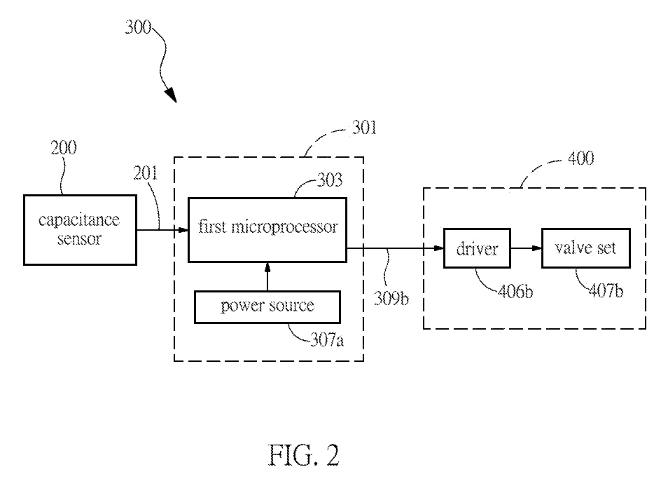

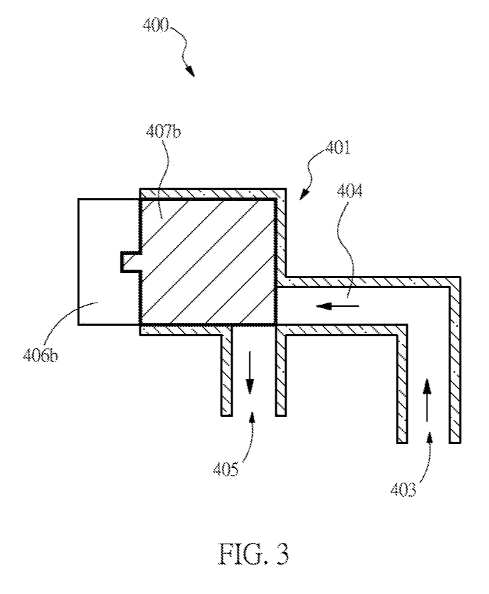

FIG. 1 is a schematic cross-sectional view of a capacitance sensing type water supply device according to the first embodiment of the present disclosure. FIG. 2 is a schematic block diagram showing a structure of a main control circuit board and a fluid control unit of a capacitance sensing type water supply device according to the first embodiment of the present disclosure. FIG. 3 is a schematic cross-sectional view of a fluid control unit according to the first embodiment of the present disclosure. Please referring to FIG. 1, FIG. 2 and FIG. 3 simultaneously, the capacitance sensing type water supply device 10 of the present disclosure includes a metal shell 100, a capacitance sensor 200, an electronic control unit 300 and a fluid control unit 400.

The metal shell 100 has an outlet 101 and an inlet 102. The outlet 101 is communicated with the inlet 102 through the flow channel 103 which is located in the metal shell 100, whereby water can flow inside the metal shell 100.

The capacitance sensor 200 is electrically connected to the metal shell 100 for sensing the electric value (e.g. the variation of a current value) of the metal shell 100, and then outputs a corresponding sensing signal 201 according to the electric value. The capacitance sensor 200 is electrically connected to the metal shell 100 through a metal connective line 202. In this embodiment, since the metal shell 100 has electric conductivity, it does not require to provide the metal shell 100 with an additional opening (such as drilling hole) for accommodating the capacitance sensor 200 or other sensors. The capacitance sensor 200 is only electrically connected to the metal shell 100, and then the capacitance sensor 200 can senses the external object. According to the infrared or microwave sensing type water supply device (e.g., faucet) that control whether water is supplied, it usually provided the infrared or microwave sensing type water supply devices with an additional opening for accommodating infrared or microwave sensor which needs to approach an outlet of the faucet in order to sense an external object conveniently. Compared with the capacitance sensing type faucet, the infrared or microwave sensing type faucet has additional manufacturing process.

The electronic control unit 300 includes a main control circuit board 301. The main control circuit board 301 includes a first microprocessor 303 (e.g., semiconductor chip) that is electrically connected to the capacitance sensor 200. The first microprocessor 303 mainly receives the sensing signal 201 outputted from the capacitance sensor 200, and generates a driving signal 309b according to the sensing signal 201. In order to conveniently supply electric power, the main control circuit board 301 further includes a power source 307a (e.g. battery) that provides electric power for the main control circuit board 301.

The fluid control unit 400 of the present disclosure includes a valve core body 401, at least one driver 406b and at least one valve set 407b. The valve core body 401 includes an inlet 403 (The valve core body 401 supplies cold or hot water), a flow channel 404 and an outlet 405, wherein the outlet 405 is communicated with the inlet 403 through the flow channel 404. In this embodiment, a driver 406b (e.g., motor) is electrically connected to the first microprocessor 305 and the valve set 407b is disposed in the valve core body 401, and then the valve set 407b is physically connected to the flow channel 404. The driver 406b drives the valve set 407b according to the driving signal 309b generated by the first microprocessor 305, whereby cold or hot water passes from the inlet 403 to the inlet 102 of the metal shell 100 through the outlet 405.

The valve set 407b can be a metal valve core. The metal valve core includes a screw nut, a control rod and a throttling plate (not shown in FIG. 3). The screw nut can mount the lower portion of control rod and the throttling plate in the valve core body 401. The throttling plate includes at least one tadpole shaped aperture which is corresponding to an end of the flow channel 404. When the control rod rotates the throttling plate, an overlapping area between the tadpole shaped apertures and the flow channel 404 can be adjusted (i.e., the flow rate of the water of the flow channel 404 into the chamber of the valve set 407b can be adjusted). Then, the water in a chamber of the valve set 407b enters the outlet 405 through an aperture of the chamber. Therefore, the valve set 407b is adapted to control whether the water of the capacitance sensing type water supply device 10 is supplied and whether the flow rate of the supplied water is changed.

The capacitance sensing type water supply method according to the first embodiment of the present disclosure are detailedly illustrated in the following mode individually, such as the water supply mode, the stop mode and the flow rate control of supplied water.

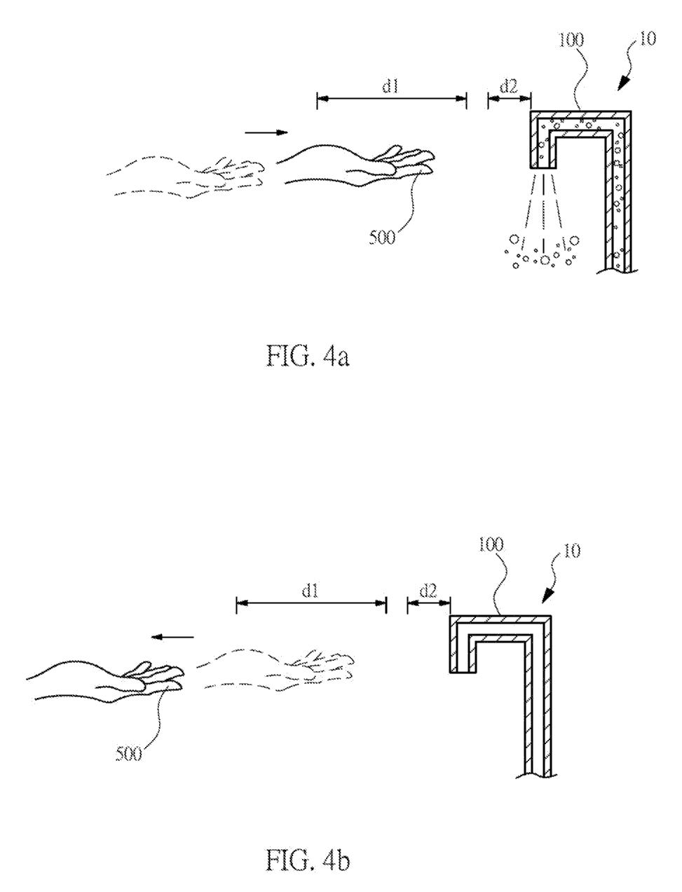

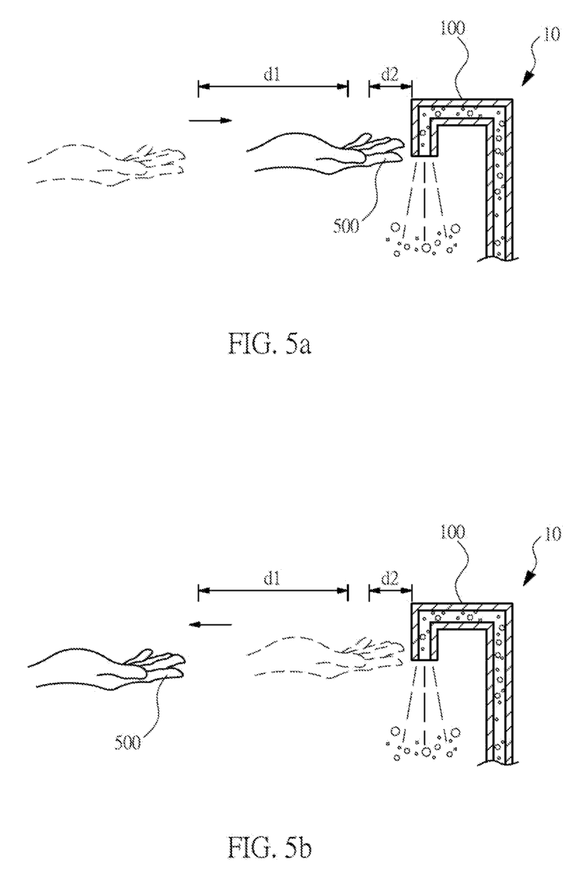

Referring to FIG. 4a, FIG. 4b, FIG. 5a and FIG. 5b, when the user want to wash his hand, the hand 500 (e.g., the external object is the hand 500 in following illustrations) has to approach the metal shell 100. When there is a first distance range d1 or a second distance range d2 between the metal shell 100 and the hand 500 (e.g., the first distance range is 3 to 10 centimeters between the hand 500 and the metal shell 100, and the second distance range is 0 to 2 centimeters between the hand 500 and the metal shell 100), the capacitive effect is processed between the hand 500 and the metal shell 100, and then the corresponding variation of current value (i.e., electric value.) is generated by the metal shell 100. The first distance range d1 can be larger than the second distance range d2. The distance between the hand 500 and the metal shell 100 within the first distance range d1 is bigger than the distance between the hand 500 and the metal shell 100 within the second distance range. Now, the capacitance sensor 200 senses the electric value of the metal shell 100, and then outputs a sensing signal 201. The intensity of the electric value is inversely proportional to the distance between the metal shell 100 and hand 500. When the intensity of the electric value is greater, the distance between the metal shell 100 and the hand 500 is shorter. In other words, the intensity of the electric value in the first distance range d1 (e.g., 3 to 10 centimeters) between the metal shell 100 and the hand 500 is smaller than the intensity of the electric value in the second distance range d2 (e.g., 0 to 2 centimeters) between the metal shell 100 and the hand 500.

FIG. 4a is a first schematic view showing the first embodied example of a capacitance sensing type water supply method according to the first embodiment of the present disclosure. FIG. 4b is a second schematic view showing the first embodied example of a capacitance sensing type water supply method according to the first embodiment of the present disclosure. Referring to FIG. 4a and FIG. 4b continuously and referring to FIG. 2 and FIG. 3, the first embodied example is the mode which controls whether water is supplied: when the hand 500 approaches the metal shell 100 from the outside of the first distance range d1 to the inside of the first distance range d1 (as shown in FIG. 4a), the capacitance sensor 200 can senses the variation of the current value (i.e., electric value) of the metal shell 100 itself. The capacitance sensor 200 outputs the sensing signal 201 that is a water supply signal according to the electric value. When the main control circuit board 301 receives the sensing signal 201, the main control circuit board 301 outputs a driving signal 309b to the driver 406b of the fluid control unit 400. Now, the driving signal 309b is an open signal, whereby the driver 406b drives the valve set 407b for controlling the water of the capacitance sensing type water supply device 10 to be supplied. The control type of the driver 406b and the valve set 407b has been mentioned in the aforementioned so it does not need to repeat here.

When the hand 500 leaves the metal shell 100 from the inside of the first distance range d1 to the outside of the first distance range d1 (as shown in FIG. 4b), the capacitance sensor 200 cannot sense the variation of the current value of the metal shell 100 (i.e., the electric value is zero) Therefore, the capacitance sensor 200 outputs the sensing signal 201 that is a no water supply signal according to the electric value. When the main control circuit board 301 receives the sensing signal 201, the main control circuit board 301 outputs a driving signal 309b to the driver 406b of the fluid control unit 400. Now, the driving signal 309b is a close signal, whereby the driver 406b drives the valve set 407b for controlling the water of the capacitance sensing type water supply device 10 to be not supplied.

FIG. 5a is a first schematic view showing the second embodied example of a capacitance sensing type water supply method according to the first embodiment of the present disclosure. FIG. 5b is a second schematic view showing the second embodied example of a capacitance sensing type water supply method according to the first embodiment of the present disclosure. Referring to FIG. 5a and FIG. 5b continuously and referring to FIG. 2 and FIG. 3, the second embodied example is the mode for controlling whether water is supplied continuously: when the hand 500 approaches (or touches) the metal shell 100 in the second distance range d2 for the first time (e.g., the hand 500 dose not touch the metal shell 100 shown in FIG. 5a), the capacitance sensor 200 can sense the variation of the current value of the metal shell 100 itself (it is bigger than the variation of the current value of the metal shell 100 during the hand 500 in the first distance range d1). Therefore, the capacitance sensor 200 outputs the sensing signal 201 that is a start signal of continuously supplied water according to the variation of the current value (i.e., the electric value.) of the metal shell 100, whereby the water of the capacitance sensing type water supply device 10 is supplied continuously.

When the hand 500 leaves the metal shell 100 from the inside of the second distant range d2 to the outside of the second distant range d2 for the first time (shown in FIG. 5b), the sensing signal 201 is still the start signal of continuously supplied water, whereby the water of the capacitance sensing type water supply device 10 is still supplied continuously. More detailed, the hand 500 is away from the metal shell 100 and beyond the first distance range d1. The weighting of the start signal of continuously supplied water is greater than the weighting of the stop water signal, the capacitance sensor 200 ignores the variation the current value of metal shell 100 (i.e., the electric value) that the hand 500 passes the first distance range dl and then is away from the first distance range d1, whereby the water of the capacitance sensing type water supply device 10 is still supplied continuously.

Referring to FIG. 5a again and referring to FIG. 2, the third embodied example is the flow control mode of water supply: after the second embodied example, when the hand 500 approaches (or touches) the metal shell 100 in the second distance range d2 and the hand 500 stays beyond a setting time (e.g., 2 second), the capacitance sensor 200 outputs the sensing signal 201 to be a flow rate increasing signal or flow rate decreasing signal, whereby the flow rate of water supply of the capacitance sensing type water supply device 10 is increasing or decreasing gradually. When the main control circuit board 301 receives the sensing signal 201, the main control circuit board 301 outputs a driving signal 309b to the driver 406b of the fluid control unit 400. Now, the driving signal 309b is a gradually increased signal or a gradually decreased signal, whereby the driver 406b drives the valve set 407b for controlling the flow rate of supplied water of the capacitance sensing type water supply device 10 to be increased or decreased gradually.

In the third embodied example, a gradually increased flow rate or a gradually decreased flow rate of the supplied water of the capacitance sensing type water supply device 10 indicates that: a plurality setting values are preset, the flow rate of the supplied water of the capacitance sensing type water supply device 10 is increased gradually from a lowest setting value to a highest setting value and then is decreased gradually from the highest setting value to the lowest setting value, repetitiously. For example, the first, second, third, fourth and fifth setting values are preset, the flow rate of the supplied water of the capacitance sensing type water supply device 10 is increased gradually from the first, second, third and fourth setting values to the fifth setting value and then is decreased gradually from the fifth, fourth, third and second setting values to the first setting value, repetitiously. For example, the first setting value is preset to 10 liter/minute, and the flow rate difference between two setting values is 2 liter/minute, i.e., the first setting value is the lowest setting value which is preset to 10 liter/minute, and the fifth setting value is the highest setting value which is preset to 18 liter/minute.

According to the flow rate control mode in the third embodied example of this embodiment, when the capacitance sensing type water supply device 10 start to supply water in each time, the flow rate of the supplied water of the capacitance sensing type water supply device 10 can be increased gradually from the lowest setting value.

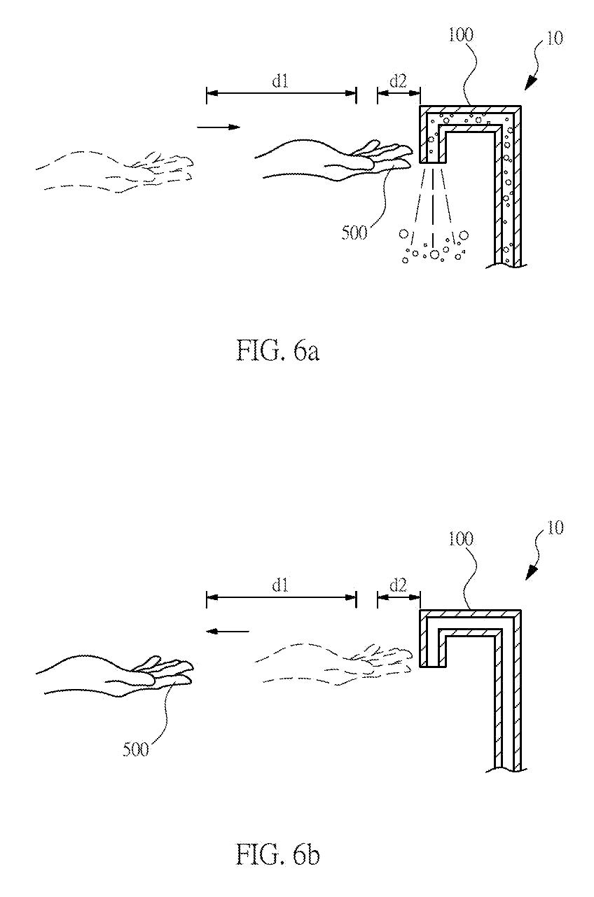

FIG. 6a is a first schematic view showing the fourth embodied example of a capacitance sensing type water supply method according to the first embodiment of the present disclosure. FIG. 6b is a second schematic view showing the fourth embodied example of a capacitance sensing type water supply method according to the first embodiment of the present disclosure. Referring to FIG. 6a and FIG. 6b continuously and referring to FIG. 2, the fourth embodied example is a stop mode of continuously supplied water: after the second embodied example, (the second embodied example indicates that: when the hand 500 approaches (or touches) the metal shell 100 in the second distance range d2 for the first time, and then leave the metal shell 100 beyond the second distance range d2, the water of the capacitance sensing type water supply device 10 is still supplied continuously), when the hand 500 approaches (or touches) the metal shell 100 in the second distance range d2 for the second time, the sensing signal 201 is a stop signal of continuously supplied water.

When the hand 500 is away from the metal shell 100 beyond the second distance range d2 for the second time, the capacitance sensor 200 outputs the sensing signal 201 to be the stop signal of continuously supplied water, whereby the water of the capacitance sensing type water supply device 10 is not supplied. The control type of the electronic control unit 300 has been mentioned in the aforementioned so it does not need to repeat here.

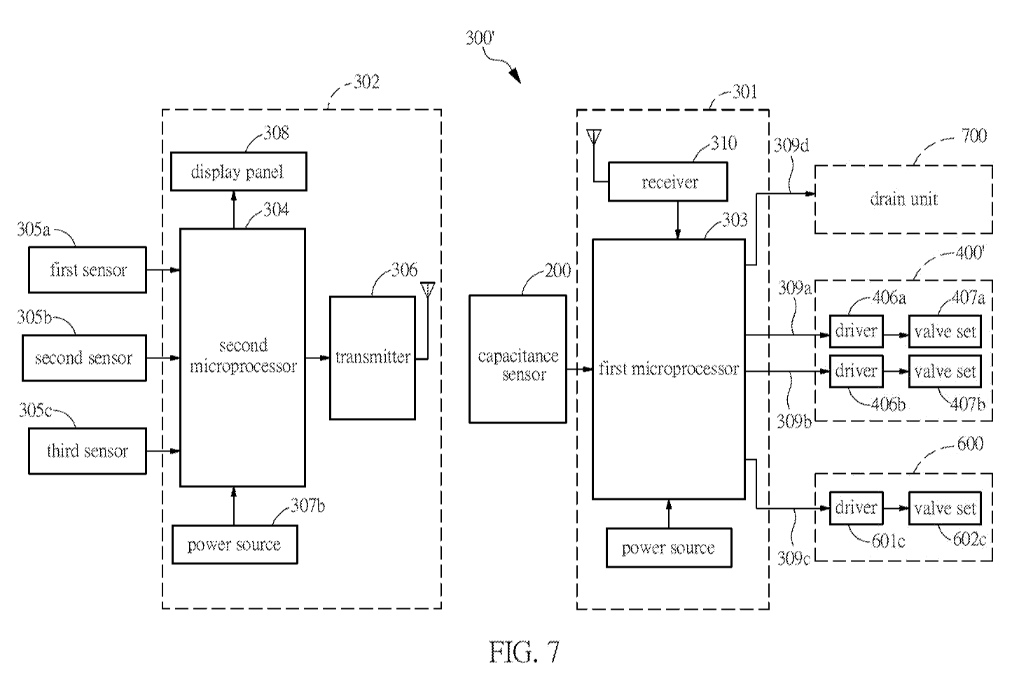

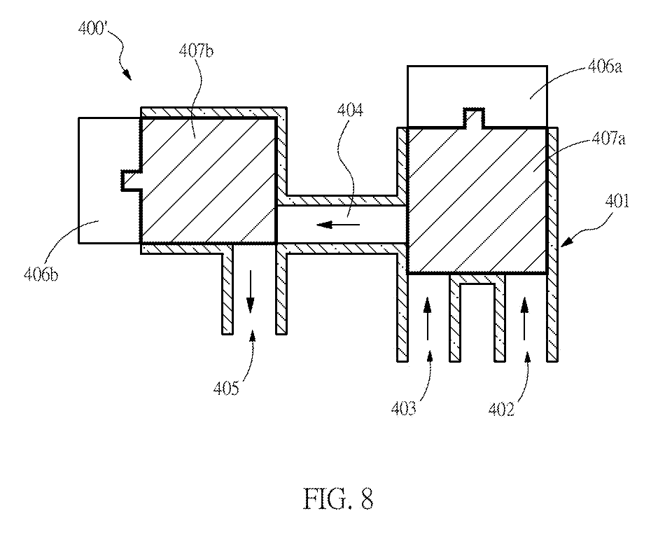

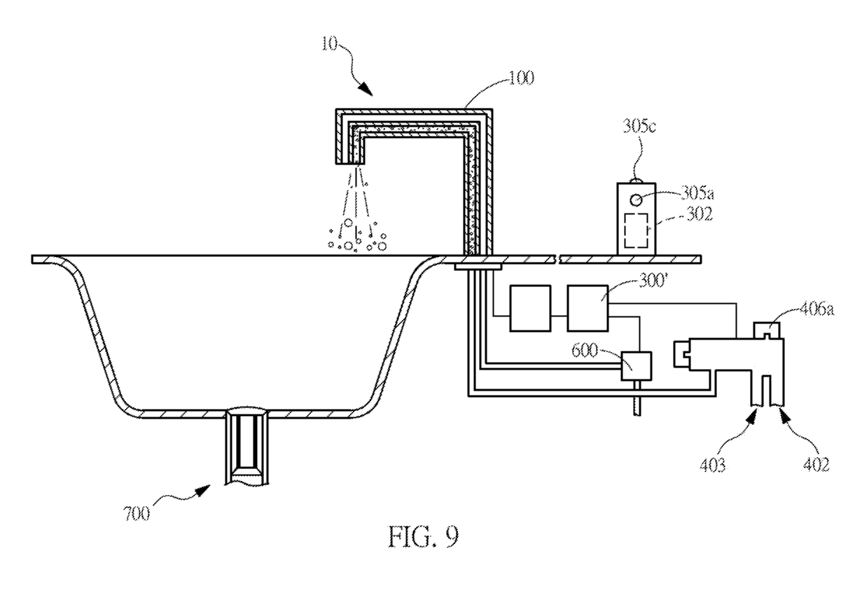

FIG. 7 is a schematic block diagram showing a structure of an electronic control unit, a fluid control unit and a drain unit according to the second embodiment of the present disclosure. FIG. 8 is a schematic cross-sectional view of a fluid control unit according to the second embodiment of the present disclosure. FIG. 9 is a schematic cross-sectional view of a capacitance sensing type water supply device according to the second embodiment of the present disclosure. In the second embodiment, the present disclosure can also use the capacitance sensor 200 to sense an external object (e.g. the hand) which approaches or touches the metal shell 100, and then drives the valve set 407b to control whether water of the capacitance sensing type water supply device 10 is supplied through the driver 406b of the fluid control unit 400′. Additionally in the second embodiment, the capacitance sensing type water supply device 10 can further control the kinds of supplied water and whether the supplied water is drained. As shown in FIG. 7, FIG. 8 and FIG. 9, the capacitance sensing type water supply device 10 further includes a potable water control unit 600 and a drain unit 700. The potable water control unit 600 is electrically connected to the first microprocessor 303 of the main control circuit board 301, and the potable water control unit 600 is adapted to receive a driving signal 309c outputted from the first microprocessor 303 for controlling whether potable water (e.g., reverse osmosis (RO) water) is supplied. The potable water control unit 600 includes a driver 601c and a valve set 602c. The operation type of the driver 601c and the valve set 602c in the second embodiment is the same with the operation type of the driver 406b and the valve set 407b in the first embodiment so it does not need to repeat here.

The drain unit 700 is electrically connected to the first microprocessor 303 of the main control circuit board 301, and the drain unit 700 is adapted to receive a driving signal 309d outputted from the first microprocessor 303 for controlling whether water is drained.

The fluid control unit 400′ in the second embodiment of the present disclosure is adapted to control whether city water is supplied, whether the flow rate of the supplied water is changed and whether the temperature of the supplied water is changed. Compared with the fluid control unit 400 in the first embodiment, the fluid control unit 400′ in the second embodiment further includes a driver 406a, a valve set 407a and an inlet 402. The driver 406a is adapted to receive a driving signal 309d outputted from the first microprocessor 303. In this embodiment, the inlet 402 is a cold water inlet and the inlet 403 is a hot water inlet. The valve set 407a can be a valve core made of metal, and the valve core made of metal includes a screw nut, a control rod and a throttling plate (not show in FIG. 8). The screw nut can be screwed and mounted to the valve core body 401 for mounting a lower portion of the control rod and the throttling plate in the valve core body 401. The control rod is physically connected to the throttling plate, and the lower portion of the control rod includes a chamber, which has apertures. The throttling plate includes two tadpole shaped apertures, which are corresponding to the inlet 402 and the inlet 403 respectively. When the control rod rotates the throttling plate, the overlapping area between one of the two tadpole shaped apertures and the inlet 402 and the overlapping area between the other one of the two tadpole shaped apertures and the inlet 403 can be adjusted simultaneously (i.e., the ratio of the fluid of the inlet 402 to the fluid of the inlet 403 into the chamber of the valve set 407b can be adjusted). Then, the mixed water in the chamber enters the flow channel 404 through the apertures of the chamber. Thus, the valve set 407a is adapted to control whether the water of the capacitance sensing type water supply device 10 is supplied or whether temperature of the supplied water is changed.

Furthermore, the electronic control unit 300′ further includes an auxiliary control circuit board 302 that is electrically connected to the main control circuit board 301 according to the second embodiment of the present disclosure. The auxiliary control circuit board 302 includes a second microprocessor 304 (e.g. semiconductor chip) and the transmitter 306 that is electrically connected to the second microprocessor 304. The auxiliary control circuit board 302 further includes an electrical power 307b (e.g. battery) that is adapted to provide the auxiliary control circuit board 302 with electrical power. In this embodiment, the second microprocessor 304 is electrically connected to a first sensor 305a, a second sensor 305b and a third sensor 305c. The first sensor 305a, the second sensor 305b and the third sensor 305c can be an infrared sensor or a microwave sensor. The auxiliary control circuit board 302 further includes a display panel 308, which is electrically connected to the second microprocessor 304 for displaying the correlative information to user. The correlative information can be the kind of the supplied water or the temperature of the supplied water etc.

The main control circuit board 301 further includes a receiver 310, which is electrically connected to the first microprocessor 303 for receiving the signal outputted from the transmitter 306 or the signal outputted from an electronic remote control device (not shown in the drawing).

Various control modes of the capacitance sensing type water supply device 10 for water supplying, no water supplying, water flow rate and water temperature according to the second embodiment of the present disclosure are described as follows:

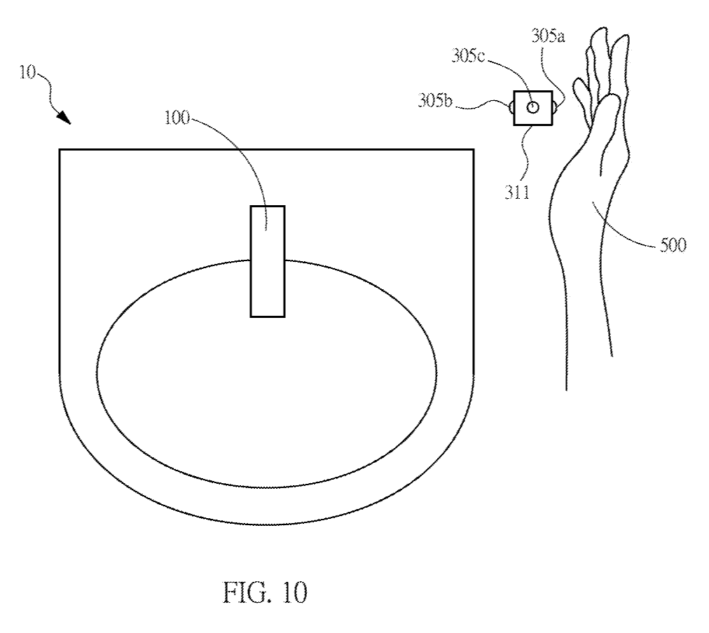

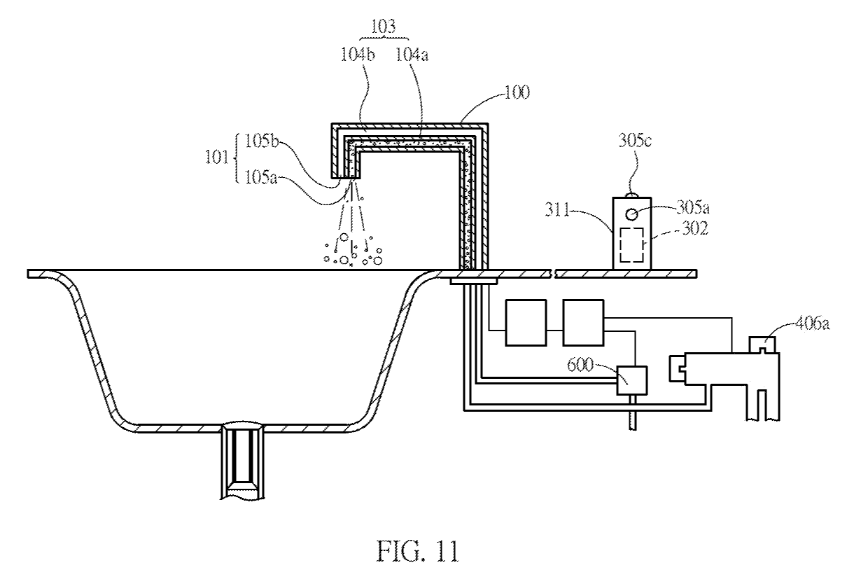

FIG. 10 is a schematic top view showing the first embodied example of a capacitance sensing type water supply method according to the second embodiment of the present disclosure. FIG. 11 is a schematic cross-sectional view showing city water supply of the first embodied example of a capacitance sensing type water supply method according to the second embodiment of the present disclosure. Referring to FIG. 10 and FIG. 11 continuously and referring to FIG. 7, the auxiliary control circuit board 302 is disposed in a box 311 and the first sensor 305a, the second sensor 305b and the third sensor 305c can sense an external object that approaches the box 311. There are a distance between the box 311 and the metal shell 100 so as to avoid an incorrect sensing signal outputted from the first sensor 305a, the second sensor 305b, the third sensor 305c or the capacitance sensor 200 when an external object (e.g., the hand) approaches to the metal shell 100.

Besides, the flow channel 103 of the metal shell 100 includes a first flow channel 104a and a second flow channel 104b for providing an user to select city water or potable water supply. The outlet 101 of the metal shell 100 includes a first outlet 105a and a second outlet 105b, whereby the fluid control unit 400 controls the city water to pass through the first flow channel 104a and then the first outlet 105a. The potable water control unit 600 controls the potable water to pass through the second flow channel 104b and then the second outlet 105b.

The first embodied example is temperature control mode of the city water supply according to the second embodiment of the present disclosure: when the water of the capacitance sensing type water supply device 10 is supplied continuously (e.g., the capacitance sensing type water supply device 10 is the water supply mode in the first or the second embodied example in the first embodiment), the first sensor 305a outputs a temperature adjust signal (i.e., a temperature increasing signal or a temperature decreasing signal) if the first sensor 305a senses the appearance of a hand 500 beyond a first setting time (e.g., 3 seconds.). The second microprocessor 304 outputs a control signal according to the temperature increasing signal or the temperature decreasing signal, and the transmitter 306 sends the control signal to the receiver 310. When the first microprocessor 303 receives the control signal outputted from the receiver 310, the first microprocessor 303 outputs a driving signal 309a to control the driver 406a and the valve set 407a (the control type of the driver 406a and the valve set 407a has been mentioned in the aforementioned so it dose not need to repeat here). The driver 406a and the valve set 407a of the fluid control unit 400 can control whether the temperature of the supplied water of the capacitance sensing type water supply device 10 is gradually increasing or decreasing.

When the temperature of the supplied water of the capacitance sensing type water supply device 10 is increasing or decreasing gradually and the first sensor 305a senses the disappearance of the hand 500 beyond the first setting time, the first sensor 305a outputs a temperature adjust signal (now, the temperature adjust signal is a temperature keeping signal), whereby the second microprocessor 304 outputs a control signal according to the temperature keeping signal. The control signal is transmitted to the transmitter 306, the receiver 310 and then the first microprocessor 303, whereby the driver 406a and the valve set 407a of the fluid controls unit 400 controls the capacitance sensing type water supply device 10 to keep the temperature of the supplied water.

The gradually increasing temperature mode or gradually decreasing temperature mode of the supplied water of the capacitance sensing type water supply device 10 is preset in a plurality setting values. The temperature of the supplied water of the capacitance sensing type water supply device 10 is increased gradually from a lowest setting value to a highest setting value and then is decreased gradually from the highest setting value to the lowest setting value, repetitiously. For example, the first, second, third, fourth and fifth setting values are preset, the temperature of the supplied water of the capacitance sensing type water supply device 10 is increased gradually from the first, second, third and fourth setting values to the fifth setting value and then is decreased gradually from the fifth, fourth, third and second setting values to the first setting value, repetitiously. For example, the first setting value is preset to 25 degrees centigrade, and the temperature difference between two setting values is 5 degrees centigrade, i.e., the first setting value is the lowest setting value which is preset to 25 degrees centigrade, and the fifth setting value is the highest setting value which is preset to 45 degrees centigrade.

In addition, according to the temperature control mode in the first embodied example, when the capacitance sensing type water supply device 10 start to supply water in each use, the temperature of the supplied water of the capacitance sensing type water supply device 10 must be increased gradually from the lowest setting value (e.g., 25 degrees), so as to prevent the temperature of the supplied water of the capacitance sensing type water supply device 10 from being high in the previous use.

In another embodied example, it can enter temperature control mode by the first sensor 305a if necessary, and then controls whether water is supplied. It is not limited by the above-mentioned embodied example.

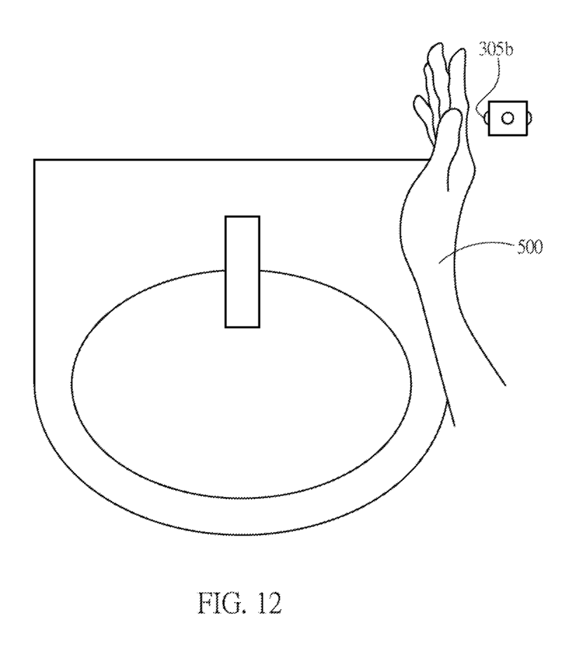

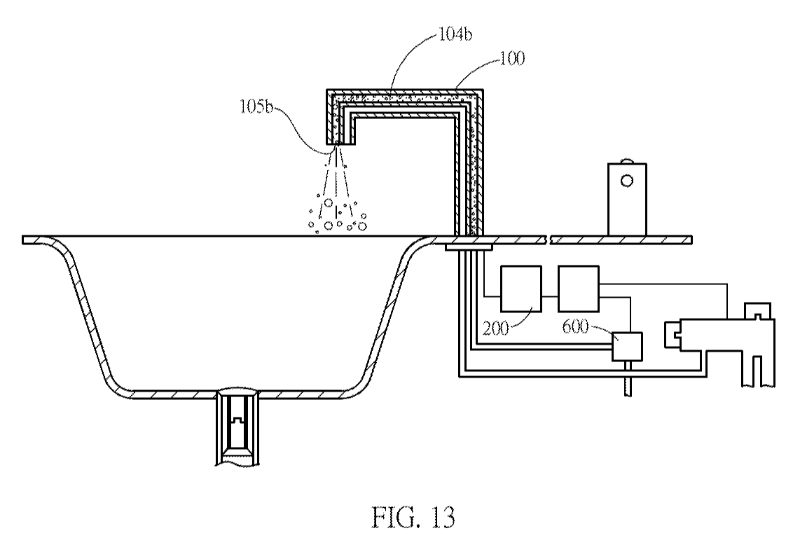

FIG. 12 is a schematic top view showing the second embodied example of a capacitance sensing type water supply method according to the second embodiment of the present disclosure. FIG. 13 is a schematic cross-sectional view showing potable water supply of the second embodied example of a capacitance sensing type water supply method according to the second embodiment of the present disclosure. Referring to FIG. 12 and FIG. 13 continuously and referring to FIG. 7, the second example according to the second embodiment of the present disclosure is potable water supply control mode: when the second sensor 305b senses the first appearance and first disappearance of the hand 500 within a second setting time (e.g. 2 seconds), the second sensor 305b outputs a potable water signal (now, the potable water signal is a potable water supply signal), whereby the second microprocessor 304 outputs a control signal according the potable water supply signal and the control signal be sent to the receiver 310 through transmitter 306. When the first microprocessor 303 receives the control signal outputted from the receiver 310, the first microprocessor 303 outputs a driving signal 309c to control the driver 601c and the valve set 602c of the portable water control unit 600. The driver 601c and the valve set 602c drives portable water to flow through the flow channel 104b and then the outlet 105b, whereby the portable water of the capacitance sensing type water supply device 10 is supplied.

Furthermore, when the second sensor 305b senses a second appearance and a second disappearance of the hand 500 within a second time (e.g., 2 seconds), the second sensor 305b outputs a potable water signal (now, the potable water signal is a no potable water supply signal), whereby the second microprocessor 304 outputs a control signal according the no potable water supply signal, and the control signal is sent to the receiver 310 through transmitter 306. When the first microprocessor 303 receives the control signal outputted from the receiver 310, the first microprocessor 303 outputs a driving signal 309c to control the driver 601c and the valve set 602c, whereby the portable water of the capacitance sensing type water supply device 10 is not supplied.

The sensing signal outputted from the capacitance sensor 200 and the second sensor 305b of the present disclosure can control two kinds of city water supply and portable water supply of the capacitance sensing type water supply device 10.

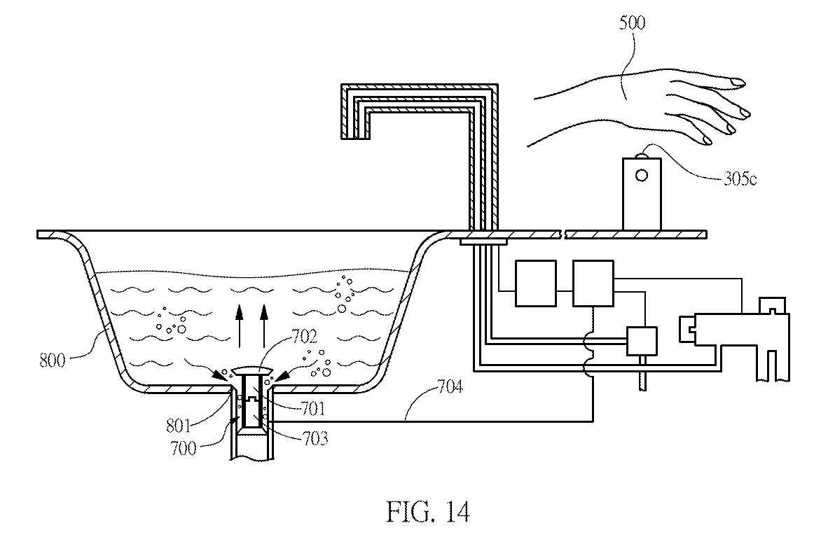

FIG. 14 is a schematic cross-sectional view showing drain of the third embodied example of a capacitance sensing type water supply method according to the second embodiment of the present disclosure. Referring to FIG. 14 continuously and referring to FIG. 7, the drain unit 700 in the second embodiment of the present disclosure is electrically connected to the first microprocessor 303 of the main control circuit board 301 through a signal connecting line 704, wherein the drain unit 700 is communicated with a drainage outlet 801 of a container 800, and the drain unit 700 includes a transmission 701, a stopper 702 and a driver 703. For example, the stopper 702 can be screwed to a front end of the transmission 701, e.g., an inner thread of the stopper 702 is screwed to an outer thread of the front end of the transmission 701. The driver 703 is mechanically connected to the transmission 701 by means of a helical thread. A rotary motion of the driver 703 is transformed to a linear motion of the transmission 701 by means of the helical thread having a function of a lipstick that the rotary motion can be transformed to the linear motion.

The third embodied example shows a sensing type drain step according the second embodiment of the present disclosure: when the third sensor 305c senses the appearance of the hand 500, the third sensor 305c outputs a drain signal, whereby the second microprocessor 304 outputs a control signal according to the drain signal, and the control signal is sent to the receiver 310 through the transmitter 306. When the first microprocessor 303 receives the control signal outputted from the receiver 310, the first microprocessor 303 outputs a driving signal 309d, whereby the driving signal 309d controls the driver 703 of the drain unit 700 to drive the driver 701 and the stopper 702 for controlling the drain of the container 800.

When the third sensor 305c senses the disappearance of the hand 500 beyond a presetting time (e.g., 1 minute), the third sensor 305c outputs a no drain signal, whereby the second microprocessor 304 outputs a control signal according to the no drain signal, and the control signal is sent to the receiver 310 through the transmitter 306. When the first microprocessor 303 receives the control signal outputted from the receiver 310, the first microprocessor 303 outputs a driving signal 309d, whereby the driving signal 309d controls the driver 703 of the drain unit 700 to drive the driver 701 and the stopper 702 for controlling no drain of the container 800.

According to the foregoing, the present disclosure mainly utilizes two kinds of distance between the external object (e.g., hand) and the metal shell (e.g., faucet shell) to generate a capacitive effect between the external object and the metal shell when the external object touches or doesn't touch the metal shell, whereby the variation of a current value of the metal shell is sensed by the capacitance sensor, and the electronic control unit and the fluid control unit are utilized to control whether water of the capacitance sensing type water supply device is supplied, whether water is supplied continuously and whether the flow rate of the supplied water is changed. Moreover, simultaneously the present disclosure can utilizes the first to third sensor of the electronic control unit to control whether temperature of the supplied water is changed, whether the potable water is supplied and whether the supplied water is drained.

The foregoing is considered as illustrative only of the implementation manners or embodiments of the technical solutions adopted by the present disclosure to solve the problems and it's not desired to limit the scope of the disclosure. Accordingly, all suitable modifications and equivalents may be resorted to, falling within the scope of the disclosure.

What is claimed is:

1. A capacitance sensing type water supply device, comprising:
a metal shell comprising an inlet, a flow channel and an outlet communicated with the inlet through the flow channel, wherein there is a capacitive effect between an external object and the metal shell when a distance between the external object and the metal shell is within a first distance range or a second distance range, and the distance between the external object and the metal shell within the first distance range is bigger than the distance between the external object and the metal shell within the second distance range, whereby a corresponding electric value is generated by the metal shell;
a capacitance sensor electrically connected to the metal shell, and adapted to sense the electric value of the metal shell and then to output a corresponding sensing signal according to the electric value;
an electronic control unit electrically connected to the capacitance sensor, and adapted to receive the sensing signal and then to generate a corresponding driving signal; and
a fluid control unit communicated with the inlet of the metal shell, wherein:
when the distance between the external object and the metal shell is within the first distance range, the fluid control unit controls whether water of the capacitance sensing type water supply device is supplied according to the driving signal; and
when the distance between the external object and the metal shell is within the second distance range, the fluid control unit controls whether water of the capacitance sensing type water supply device is supplied continuously or a flow rate of supplied water according to the driving signal.

2. The capacitance sensing type water supply device according to claim 1, wherein the electronic control unit comprises a main control circuit board comprising a first microprocessor that is electrically connected to the capacitance sensor, and adapts to receive the sensing signal and then to generate the corresponding driving signal.

3. The capacitance sensing type water supply device according to claim 1, wherein:
when the external object approaches the metal shell from the outside of the first distance range to the inside of the first distance range, the sensing signal is a water supply signal, whereby the water of the capacitance sensing type water supply device is supplied; and
when the external object leaves the metal shell from the inside of the first distance range to the outside of the first distance range, the sensing signal is a stop water supply signal, whereby the water of the capacitance sensing type water supply device is not supplied.

4. The capacitance sensing type water supply device according to claim 1, wherein:
when the external object approaches or touches the metal shell in the second distance range for the first time, the sensing signal is a continuous water supply signal, whereby the water of the capacitance sensing type water supply device is supplied continuously; and
when the external object leaves the metal shell from the inside of the second distance range to the outside of the second distance range for the first time, the sensing signal is still a continuous water supply signal, whereby the water of the capacitance sensing type water supply device is still supplied continuously.

5. The capacitance sensing type water supply device according to claim 4, wherein when the external object approaches or touches the metal shell in a second distance range and the external object stays beyond a setting time, the sensing signal is a flow rate increasing signal or a flow rate decreasing signal, whereby the flow rate of supplied water of the capacitance sensing type water supply device is increasing or decreasing gradually.

6. The capacitance sensing type water supply device according to claim 4, wherein:
when the water of the capacitance sensing type water supply device is supplied continuously and the external object approaches or touches the metal shell in the second distance range for the second time, the sensing signal is a stop continuous water supply signal, whereby the water of the capacitance sensing type water supply device is not supplied continuously; and
when the external object leaves the metal shell beyond the second distance range for the second time, the sensing signal is still a stop continuous water supply signal, whereby the water of the capacitance sensing type water supply device is still not supplied continuously.

7. The capacitance sensing type water supply device according to claim 5, wherein a flow rate increasing mode or a flow rate decreasing mode of the supplied water of the capacitance sensing type water supply device indicates that: a plurality setting values are preset, the flow rate of the supplied water of the capacitance sensing type water supply device is increased gradually from a lowest setting value to a highest setting value and then is decreased gradually from the highest setting value to the lowest setting value, repetitiously.

8. The capacitance sensing type water supply device according to claim 2, wherein:
the capacitance sensing type water supply device further comprises a portable water control unit and a drain unit that are electrically connected to the first microprocessor of the main control circuit board individually;
the electronic control unit further comprises an auxiliary control circuit board that is electrically connected to the main control circuit board, wherein the auxiliary control circuit board comprises a second microprocessor and a transmitter that is electrically connected to the second microprocessor, and the second microprocessor is electrically connected to a first sensor, a second sensor and a third sensor for outputting a temperature adjust signal, a portable water signal and a drain signal respectively; and
the main control circuit board further comprises a receiver that is electrically connected to the first microprocessor for receiving the signal from the output of the receiver.

9. The capacitance sensing type water supply device according to claim 8, wherein the flow channel of the metal shell comprises a first flow channel and a second flow channel, the outlet of the metal shell comprises a first outlet and a second outlet, whereby the fluid control unit controls city water to pass through the first flow channel and then the first outlet, and controls the portable water to pass through the second flow channel and then the second outlet.

10. The capacitance sensing type water supply device according to claim 1, wherein the intensity of the electric value between the external object and the metal shell is within the first distance range is smaller than the intensity of the electric value between the external object and the metal shell is within the second distance range.

11. A capacitance sensing type water supply method, comprising steps of:
providing a metal shell and a capacitance sensor electrically connected to the metal shell, wherein when a distance between an external object and the metal shell is within a first distance range or a second distance range, and the distance between the external object and the metal shell within the first distance range is bigger than the distance between the external object and the metal shell within the second distance range, the capacitance sensor is adapted to sense an electric value of a capacitive effect between the metal shell and the external object, and then generates a sensing signal individually;
when the external object approaches the metal shell from the outside of the first distance range to the inside of the first distance range, the sensing signal is a water supply signal, whereby the water of the capacitance sensing type water supply device is supplied; and when the external object leaves the metal shell from the inside of the first distance range to the outside of the first distance range, the sensing signal is a stop water supply signal, whereby the water of the capacitance sensing type water supply device is not supplied;
when the external object approaches or touches the metal shell in the second distance range for the first time, the sensing signal is a continuous water supply signal, whereby the water of the capacitance sensing type water supply device is supplied continuously; and when the external object leaves the metal shell from the inside of the second distance range to the outside of the second distance range for the first time, the sensing signal is still the continuous water supply signal, whereby the water of the capacitance sensing type water supply device is still supplied continuously; and
when the water of the capacitance sensing type water supply device is supplied continuously and the external object approaches or touches the metal shell in the second distance range for the second time, the sensing signal is a stop continuous water supply signal, whereby the water of the capacitance sensing type water supply device is not supplied continuously; and when the external object leaves the metal shell from the inside of the second distance range to the outside of the second distance range for the second time, the sensing signal is still a stop continuous water supply signal, whereby the water of the capacitance sensing type water supply device is still not supplied continuously.

12. The capacitance sensing type water supply method according to claim 11, wherein when the external object approaches or touches the metal shell in the second distance range and the external object stays beyond a setting time, the sensing signal is a flow rate increasing signal or flow rate decreasing signal, whereby the flow rate of supplied water of the capacitance sensing type water supply device is increasing or decreasing gradually.

13. The capacitance sensing type water supply method according to claim 12, wherein a flow rate increasing mode or a flow rate decreasing mode of the supplied water of the capacitance sensing type water supply device indicates that: a plurality setting values are preset, the flow rate of the supplied water of the capacitance sensing type water supply device is increased gradually from a lowest setting value to a highest setting value and then is decreased gradually from the highest setting value to the lowest setting value, repetitiously.
